(19) United States
(12) Patent Application Publication
(10) Pub. No.: US 2002/0010915 A1
(43) Pub. Date: Jan. 24, 2002

(54) Provider transfer server and a method of providing a provider transfer service

(75) Inventor: Toshikatsu Maeda, Gunma (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/823,242

(22) Filed: Mar. 30, 2001

(30) Foreign Application Priority Data
Jun. 13, 2000 (JP) 2000-177537

(51) Int. Cl. G06F 9/455

(52) U.S. Cl. 717/11

(57) ABSTRACT

A server is provided between a plurality of Internet service providers and a plurality of user nodes. The server chooses an appropriate Internet service provider to which a user node is to be connected, according to a user's preference. When the user node is dial-up connected to the server, the server dials up on the Internet service provider which suits the user's preference. After the connection between the user node and the server and the connection between the server and the Internet service provider are established, the server records a connection time and so on of a session in question and uses the thus recorded data for calculating fee to be charged.

### BACKGROUND OF THE INVENTION

1. Field of the Invention

The present invention relates to a provider transfer servicing technology, and it particularly relates to a provider transfer server which performs a connection service and its provider transfer service method, in an environment where there exist a plurality of connection service providers which take care of connection service to a network, and a user node which requests the connection to the network.

2. Description of the Related Art

The Internet was primarily used in academic settings and mainly used for search of certain information. Recently, the Internet becomes indispensable, as an infrastructure of electronic business transactions, for so-called B to B (a link between businesses), B to C (a link from business to consumers) and C to C (a link between consumers) . It is obvious from the recent economic boom evidenced in the U.S. that IT or information technology is a major driving force of the economic development. Thus, it is a very important object, among other things, to maintain and expand the communication infrastructure which is a backbone of IT. In order to offer a wide range of consumers a faster and more comfortable network environment, various projects are under way led by private organizations and as government-led policies.

However, present conditions which surround the consumers who utilize the Internet are not so desirable. The consumers must bear, on their major parts, the communication expenses and the connection charge to get connected to the Internet in order to use various services available on the Internet.

FIG. 1 illustrates a structure of the system 10 in which a consumer (referred to as a user hereinafter) gets connected to the Internet by a dial-up connection. Through a public network 16 a user node 18 dials to an internet service provider 14 (referred to as an ISP 14 hereinafter) to which the user made a contract, so as to attempt to establish a connection. The ISP 14 is connected to the Internet 14 via an exclusive line, so that the user node 18 is connected to the Internet 12 by the ISP 14.

The communication expenses occur when the user dials to the ISP 14 while the connection charge comes into effect as a handling fee of ISP 14. In order to keep the communication charges as low as possible, consumers in general use the dial-up connection instead of a permanent connection. On the other hand, in order to keep the connection charge low, it is necessary for the consumers to find a service provider whose service charge is relatively low, among many other ISP's flooded into this business sector.

No further capability is primarily required once the ISP connects the user to the Internet. Thus, for the user it suffices that there is an ISP which offers a comfortable connection environment, and no strong brand recognition for the ISP is necessary. Thus, the users tend to make contract with the ISP whose connection fee is cheaper, so that, for example, the users attempt to establish connection at a single access point or few available access points of the ISP. As a result thereof, a situation occurs in which the line becomes almost always busy, so that the connection is hardly established, in spite of the cheap connection fee. On the other hand, the ISP where the connection tends to be established rather easily, oftentimes charges a relatively high connection fee, thus creating a dilemma to the user wishing to use the Internet frequently.

### SUMMARY OF THE INVENTION

The present invention has been made in view of the foregoing circumstance, and an object thereof is to provide a technology by which the user node gets connected to the network in a desirable manner. Another object thereof is to provide a connection technology from which the network-connection service providers also profit.

The embodiments according to the present invention relate to a provider transfer server (also referred to as a server hereinbelow). The provider transfer server which provides a predetermined service for a user node, the server comprises: a first communication unit which serves as an access point connected from the user node; a second communication unit which connects the server to any one of access points owned by a plurality of connection service providers; a detection unit which detects a connection service state of a plurality of the connection service providers; a selection unit which selects a connection service provider based on the state detected by the detection unit and which instructs said second communication unit to get connected to an access point of the connection service provider selected; and a communication channel establishing unit which establishes a communication channel between the first and second communication units in the event that the second communication unit is connected to the access point of the selected connection service provider.

As an example of a provider, there is available the ISP mentioned above, and of course any other connection-related service providers may serve as the provider. As an example of connection methods, there is available the dial-up connection which realizes PPP (Point-to Point Protocol), and of course any other methods or protocols may serve as such.

In this structure, the user node is first connected to the first communication unit as an access point. Moreover, the connection service state of a plurality of the providers, for example, the line congestion degree and the connection fee, are detected. Based on the detected state, selected is a provider whose line is open and connection fee is cheaper, for example, and which is thus suitable for the user's merit, so that the second communication unit is connected to the access point of the provider. At this point, a connection is established between the user node and the first communication unit, and another connection is established between the second communication unit and a provider. Thereafter, a communication channel is established between the first and second communication units, and finally the user node is connected to the provider in a manner that the server plays a role of a relay station. Thus, as long as the user gets connected to the server, the server takes care of connecting the user to an appropriate provider, so as to achieve high usability and increased convenience to the user.

The server may further comprise: an authenticating unit which authenticates that the user node is a legitimate user of the provider transfer server; and an authentication data supplying unit which, upon request of authentication from the connection service provider, supplies data necessary for the requested authentication. A user ID and a password serve as examples of the “data necessary for the requested authentication”.

By implementing this structure, the user needs only to make contract with an operator of the server, and it suffices that the server makes contract with the provider on behalf of the user. Thus, the user has increased usability and convenience. Moreover, instead of that each provider charges the connection fee to a plurality of users, the connection fee can be charged collectively to the contracting server. Moreover, each provider needs not to actually recognize the users connected to each provider, and but to recognize that the server gets connected to the provider. Namely, the server is regarded as one of users whose connection time to the provider is long.

The server may further comprise: a recording unit which records sessions where the communication channel is established for the connection service provider, for each connection service provider; and a charge unit which calculates a service fee incurred by a user for each connection service provider, based on data of the session recorded by the recording unit. When the line of a provider is rather vacantly open, the server connects the user to such a provider, so that the provider can enjoy additional revenue of the connection fee. Thereby, it is desirable to the provider that the line usage rate of such the provider will increase when the line is not busy, and a part of the revenue of the connection fee thus earned will be reimbursed to the operator of the server as an introduction handling fee. The structure may be such that the server bears the communication cost which is otherwise paid by the user node when connecting the server, on the condition that the server enjoys this introduction handling fees. This is a type of the collect call scheme, so to speak.

Since the users are introduced by the server, the provider can eliminate overhead cost which is otherwise used in finding new clients (users). Thus, a site which has not received access from general users can earn the revenue as a commercial provider by opening the idle line capacity to the provider transfer server.

When the server behaves as a sole user, on behalf of a plurality of the users, to the provider, each provider charges the connection fee to the operator of the provider. The connection fee corresponds to the total of the connection fees incurred when each user gets connected to each provider. Thus, the charge unit may calculate for each user an allotted fee of the connection fee the operator of server paid to the providers, based on session data, and may charge to each user. Since this allotted fee is one which must be eventually paid by the user, there is no adverse effect on the user's part. Rather, this is a merit for there is no need of making cumbersome contracts with various providers.

While the selected provider connects the user node to the Internet, the second communication unit and a plurality of the connection service providers may be connected in an area more local than the Internet. For example, there is available a structure such that the server is interposed between the user node and an access point of the provider. The public network is generally used up to the access point, and the server may be connected to the user node and the provider at a level of the public network. When the user node and the server are connected in a local area which is not yet in the Internet area, such a structure is advantageous in terms of security and it is easy for the provider to treat the server as a user. Moreover, when, for example, the structure is such that the server is connected to the provider by the dial-up connection, the provider needs not to change its structure, thus being advantageous in carrying out its services.

Another embodiment according to the present invention relates to a method of providing a provider transfer service. The method comprising: detecting, at a proper timing, a connection service state in a plurality of connection service providers which provide connection services to network; receiving a request in which a user node requests to get connected to the network; selecting a connection service provider according to the state detected; and relaying a communication between the connection service provider thus selected and the user node. Through these processes, an intermediary process is performed in a manner such that the provider transfer service is treated as a user, by the connection service provider thus selected while the user node is treated as a user by the provider transfer service. Thus, it is advantageous in that a user only makes a single contract with the server but the user can still make use of a plurality of the providers through the server.

Moreover, this summary of the invention does not necessarily describe all necessarily features so that the invention may also be sub-combination of these described features.

### BRIEF DESCRIPTION OF THE DRAWINGS

FIG. 1 illustrates a structure of the conventional system in which a user gets connected to the Internet by a dial-up connection.

FIG. 2 illustrates a structure of a system 50 including a provider transfer server 60 according to an embodiment of the present invention.

FIG. 3 is a block diagram showing a structure of the server 60.

FIG. 4 is a table showing a data structure of the provider information database 110.

FIG. 5 shows a screen 22 displayed on a user terminal by means of the function of the preference registration unit 124.

FIG. 6 is a table showing data inside the user preference database 112.

FIG. 7 is a table showing data inside the session table 132.

FIG. 8 is a table showing the details of a debit note 320 to the provider ABC.

FIG. 9 is a table showing the details of a debit note 340 for the connection fee charge 340 issued to the user TARO.

FIG. 10 shows procedures for a series of processes performed between the ISP 14, the server 60 and the user node 18.

FIG. 11 is a screen, showing the most recent state of the ISP 14, displayed on the user terminal.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

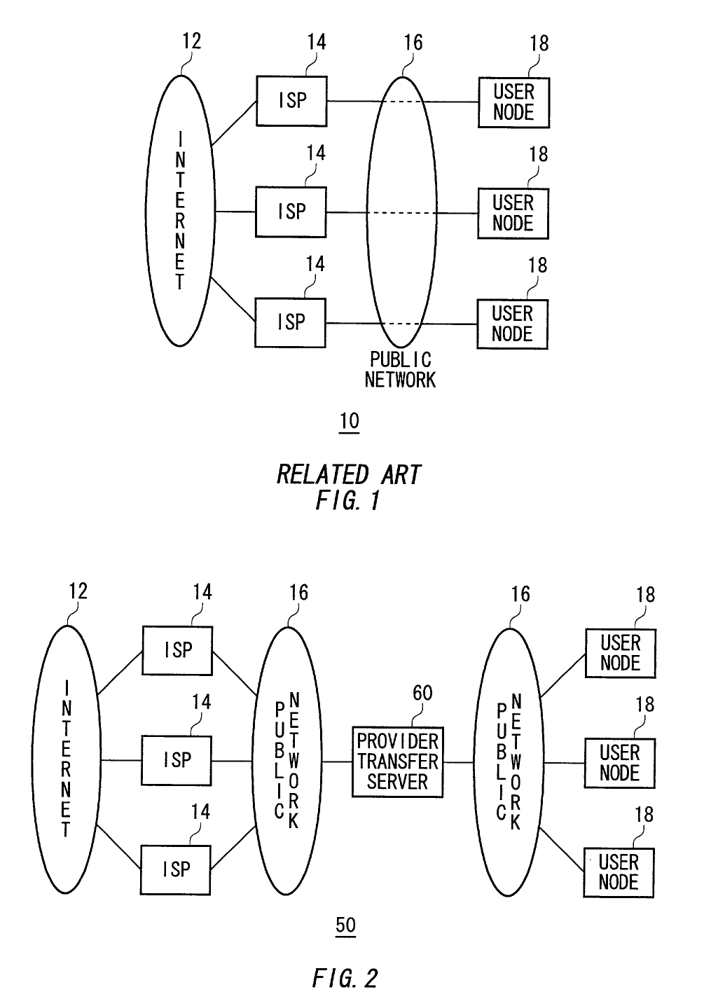

FIG. 2 illustrates a structure of a system 50 including a provider transfer server 60 according to an embodiment of the present invention. The same structural components as those shown in FIG. 1 are given the identical reference numerals, and different portions therefrom will be described here. The provider transfer server 60 is connected to a plurality of user nodes 18, and a plurality of internet service providers (ISP) 14 and public networks 16. The server 60 is connected to the user node 18 by a dial-up connection, and the server 60 is dial-up connected to the ISP 14. The user node 18 has a contract with an operator of the server 60, so that the user node 18 can establish a connection to an access point of the server 60 at any time. On the other hand, when the user node 18 is connected to the server 60, the server 60 selects an ISP 14 most suitable, among a plurality of the ISP's 14, for the user node 18 according to a user preference and the like, so as to establish a connection to said then selected ISP 14 (also referred to as a selected ISP 14 hereinbelow). Thereafter, a communication channel between the user node 18 and the selected ISP 14 is generated in the server 60, so that the server 60, serving as a relay station, connects both parties. At this point, the access point of the user node 18 is in fact moved to the selected ISP 14.

The ISP 14 may independently have a contract directly with a user besides the users via the server 60. However, since the user who is under contract with the server 60 (also referred to as a secondary user hereafter) is connected to the ISP 14 by way of the server 60, the ISP 14 does not recognize those secondary uses individually but recognize the server 60 as a single primary user. Thus, the ISP 14 charges to the primary user (i.e. the operator of the server 60) the connection fees relating to all secondary users.

On the other hand, the server 60 stores session records for each ISP 14 and user node 18, and collects the connection fees from the users which the operation of the server 60 paid to the ISP on behalf of the users. Similarly, based on the session records the operator of the server 60 charges to the user a handling fee for the service by which to connect the user to the ISP 14. Thus, macroscopically speaking, the above scheme is equivalent to the fact that the users pay the connection fee to the ISP 14 in a usual manner, while the operator of the server 60 enjoys the profit amounting to the handling fee.

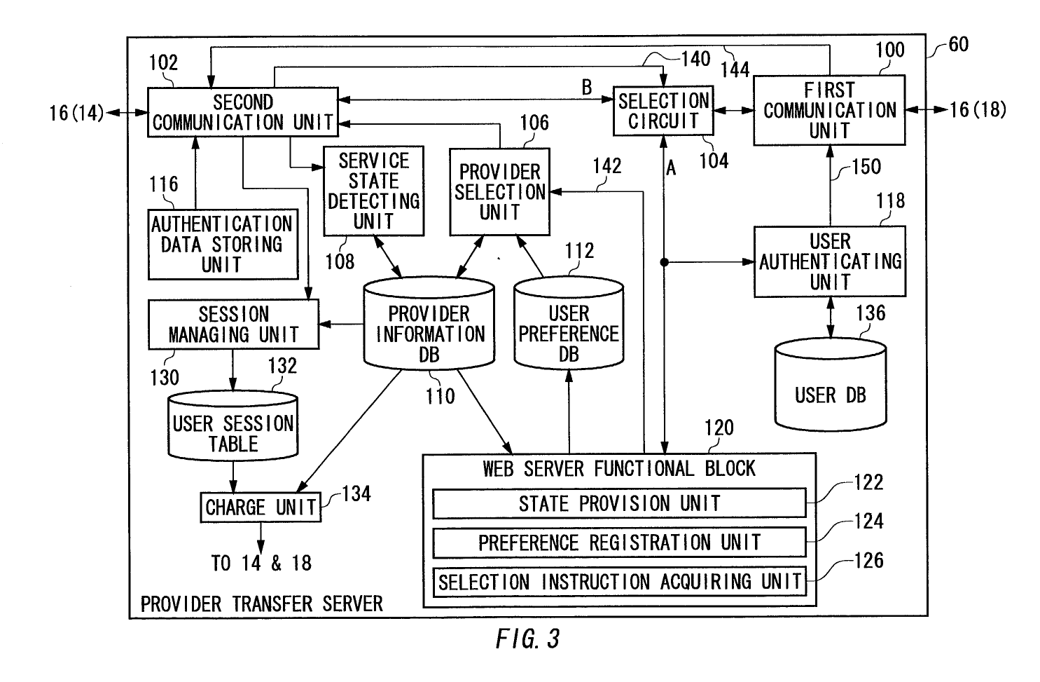

FIG. 3 is a block diagram showing a structure of the server 60. In terms of hardware components, the server 60 is usually comprised of and realized by a CPU, a memory and a provider transfer managing program loaded in the memory. It is to be understood by those skilled in the art that the way to realize such the structure and a mode of the system may vary greatly. It is to be noted that FIG. 3 does not show a hardware-oriented structure but simply a function-oriented block diagram.

A first communication unit 100 communicates with the user node 18 via the public network 16. The first communication unit 100 is mainly comprised of a modem, a terminal adapter and a communication control program. A second communication unit 102 having the similar structure to the first communication unit 100 communicates with the ISP 14 via the public network 16.

A user authenticating unit 118 authenticates a user who is dial-up connected to the first communication unit 100, based on data of a user database 136. Based on a contract made between the operator of the server 60 and the user, necessary information such as a user ID, a password, billing information and so forth are recorded in the user database 136. When the user fails to be authenticated, a disconnection instruction 150 is sent to the first communication unit 100.

A selection circuit 104 selects an object which will communicate with the first communication unit 100. Under normal conditions a path A is selected, namely the communication unit 100 communicates with a Web server functional block 120. Thus, though the server 60 seems to function as a server on WWW from the user's standpoint, its entity does not live in the Internet but behaves and functions as a Web server on the public network 16.

When the second communication unit 102 establishes a connection to the selected ISP 14, the selection circuit 104 selects a path B based on a selection signal 140 issued from the second communication unit 102. At this moment, a communication destination of the first communication unit 100 is switched from the Web server functional block 120 to the second communication unit 102, so that a communication channel is formed between the first communication unit 100 and the second communication unit 102. Thereafter, the user gets a connection service to the Internet from the selected ISP 14. When the user disconnects the connection between the user node 18 and the first communication unit 100, its disconnection signal 144 is sent to the second communication unit 102, so that the connection between the second communication unit 102 and the ISP 14 is also disconnected.

When a path between the first communication unit 100 and the second communication unit 102 is of a digital signal, the selection circuit 104 can be realized a transceiver gate having an output disable terminal. When the path between the first communication unit 100 and the second communication unit 102 is an analog signal path found on the usual public line, the selection circuit 104 may comprise a transfer gate and so forth, or may be such that, as a transfer telephone device disclosed in Japanese Patent Application Laid Open No. Sho60-198950, a transformer is provided between the first communication unit 100 and the second communication unit 102 so as to form a communication channel by electromagnetic induction.

When the second communication unit 102 made a dial-up connection to the selected ISP 14, an authentication data storing unit 116 sends data such as user ID and password, in response to an authentication request from the ISP 14. Thereby, the server 60 is recognized as a user by the selected ISP 14.

A service state detecting unit 108 detects a state of the connection server of each ISP 14 especially how congested the line is then and the connection fee, so as to be registered in a provider information database 110. Since the degree of line congestion changes constantly, it is preferably detected as often as possible. Dummy data may be downloaded by connecting to each ISP 14 at regularly recurring intervals of time so as to measure a data transfer rate. Moreover, in the case where the ISP 14 itself publicly announces the line congestion status, its data on the line congestion status may be utilized as such. When the ISP 14 has a plurality of access points, it is preferred that the line congestion status be detected for all such access points or at least a main access point. In that case, selection of an ISP 14 (described later) is made in terms of each access point.

Though the connection fee is usually fixed, it is sometimes revised, so that a content of the provider information database 110 is updated at appropriate timing via service state detecting unit 108. Since there are some ISP's 14 which changes the connection fee depending on a time period, the service state detecting unit updates the connection fee based on the present time.

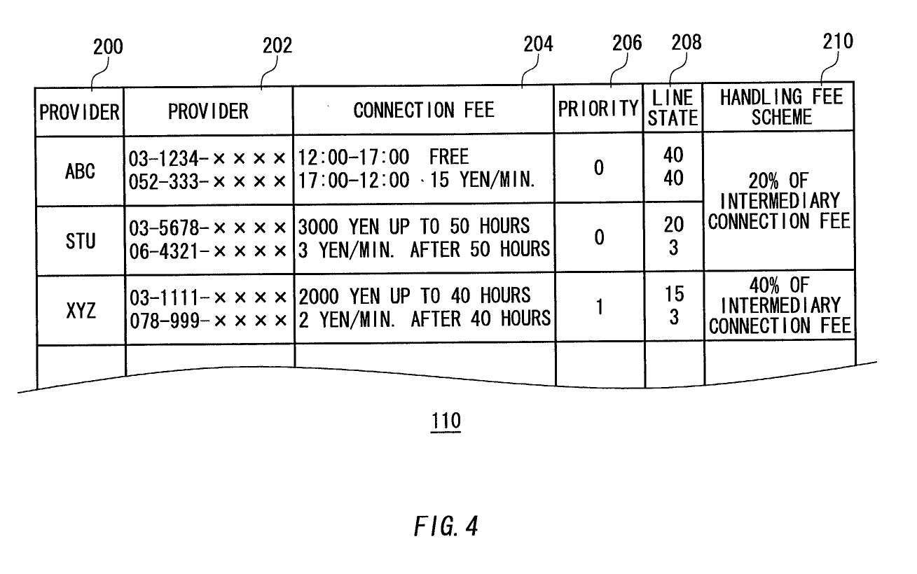

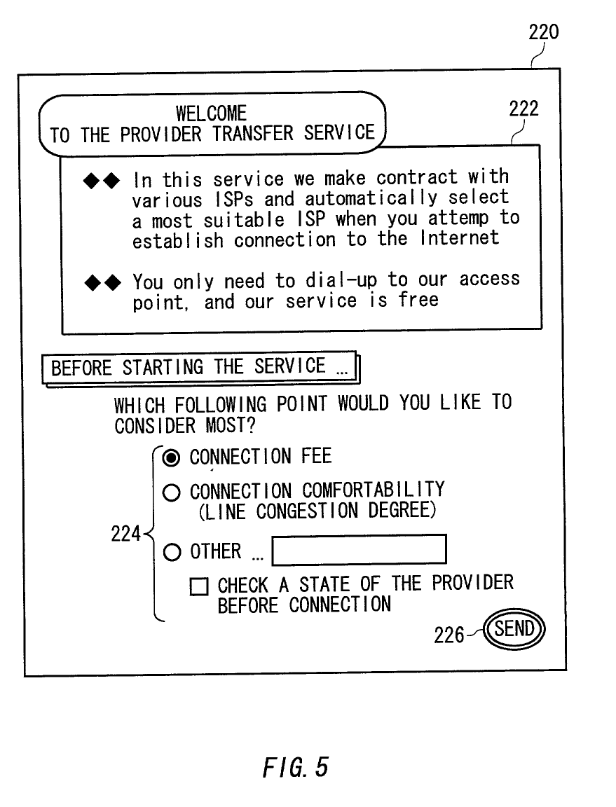

The provider information database 110 stores data on ISP's 14. FIG. 4 is a table showing a data structure of the provider information database 110. The provider information database 110 includes a provider column 200, an access point column 202, a connection fee column 204, a priority column 206, a line state column 208 and a handling fee scheme column 210. For example, the provider ABC has two access points where the connection fee during 12:00-17:00 is free due to a daytime discount or the like and is 5 yen per minute during the rest of time period.

In the priority column 206, a flag “0” is usually there while with a flag “1 ” entered the provider has a right of being connected on a priority base even if the ISP 14 presents the same condition for the user compared to other ISP's 14. The priority column 206 is set according to an intention or a request of the ISP 14, and the handling fee for said ISP 14 becomes high as described later.

The line state column 208 indicates the line congestion degree for each ISP 14, and is updated at appropriate timing by the service state detecting unit 108. Here, how may percents (%) of lines each access point owns are busy or in use is indicated. For example, 40% of the provider ABC are in use. As this number approaches 100, the line connection tends to be unsuccessful. Since as for a provider STU and a provider XYZ each provider owns an access point whose 3% is busy, it is judged in terms of the line congestion degree that the both providers present the same condition.

The handling fee scheme column 210 indicates a scheme of the handling fee (servicing fee) requested for each ISP 14 to which the operator of the server 60 connects the user. Here, 40% of intermediary connection fee is set in the provider XYZ which asks for the priority connection while 20% is set in other ISP's 14. The “intermediary connection fee” is the fee which the secondary user is supposed to pay for the connection fee and, is a revenue which the ISP 14 earns. Thus, it is this intermediary connection fee that comes into effect only when the server 60 is involved, and its rate may be set in a relatively high range. Conversely, a business model may be easily realized where the server 60 bears telephone charges for the user to get connected to the server 60. In that case, a servicing value in which the increased number of users tend to utilize the server 60 is further enhanced, thereby the ISP 14 tends to seek and make contract with the operator of the server 60.

Referring back to FIG. 3, the Web server functional block 120 includes a group of functional modules which first behaves like a Web server when the secondary user dial-ups on the server 60. A state provision unit 122 reads out states of each ISP 14 from the provider information database 110 and sends it to the user in the form of HTML document. The user can confirm this by a browser. A preference registration unit 124 engages in the selection of an ISP 14 and provides an interface which registers in advance the preference of a users. The registered preference is stored in a user preference database 112. When a user manually instructs the selection of an ISP 14, a selection instruction acquiring unit 126 acquires the data and sends them to a provider selection unit 106. The preference registration unit 124 and the selection instruction acquiring unit 126 can be realized by Common Gateway Interface (CGI) programs and the like prepared in the back of the Web server functional block 120.

FIG. 5 shows a screen 22 displayed on a user terminal by means of the function of the preference registration unit 124. Here, displayed are a service summary 222 of the server 60 and a selection item region 224 on which the user puts an emphasis in the course of selecting an ISP 14. As selection candidates, there are provided a “connection fee”, a “connection smoothness (line congestion degree)”, and a column marked with “others” in which the user can freely fill. By checking on any of these items and sending it with a click on the SEND button, the user's intention and request will be reflected on the selection of the ISP 14. Moreover, an item in which “a provider state is confirmed before connection” is provided as an option, so that the user who does not wish the server 10 to automatically select the ISP 14 may manually select an ISP 14 of his/her choice.

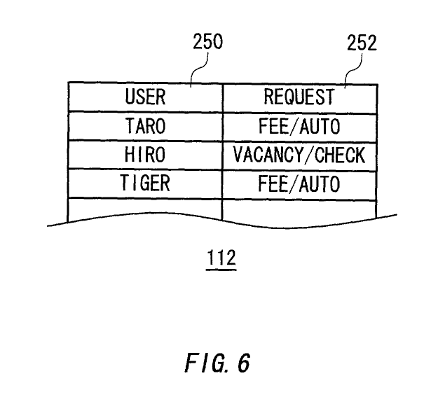

FIG. 6 is a table showing data inside the user preference database 112. Here, a user ID is entered in a user column 250 and a user's intention or request is entered in a request column 252. For example, the user “TARO” is of a type that the connection fee is emphasized, and wishes the server 60 to automatically select the ISP 14. The user “HIRO” is of a type that emphasis is placed on how open the line is then, and wishes to confirm the state of a provider every time.

Referring back to FIG. 3, the provider selection unit 106 selects the best suitable ISP 14 according to the provider information database 110, the user preference database 112 and a manual selection instruction 142 from the user. A result of the selection is notified to the second communication unit 102 so as to execute a dial-up connection.

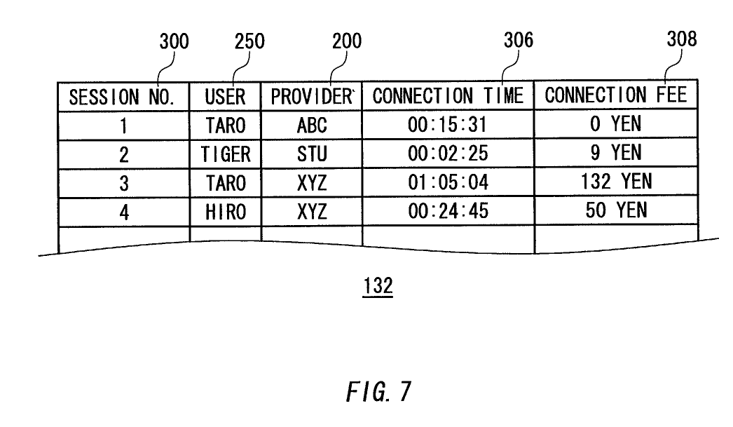

A session managing unit 130 supervises the connection state of the second communication unit 102 and the ISP 14, and its log-in is recorded in a session table 132. FIG. 7 is a table showing data inside the session table 132. The session table 132 includes a session number column 300, a user column 250, a provider column 200, a connection time column 306 and a connection fee column 308. The session number column 300 is a serial number which specifies a session. The session number column 300 and the user column 250 indicate the user node 18 and the ISP 14 which the server 60 relayed for each session. The connection time column 306 shows duration of the connection for the session, and connection fee column 308 shows an amount of fees which the ISP 14 charges for the session. The connection fee column 308 is filled by consulting with the connection time 306 and based on the connection fee column 204 of the provider information database 110. For example, the user of the session “1” is TARO and the provider thereof is ABC and the connection time thereof is 15 minutes 31 seconds, and the connection fee is 0 due to the daytime discount in the provider ABC.

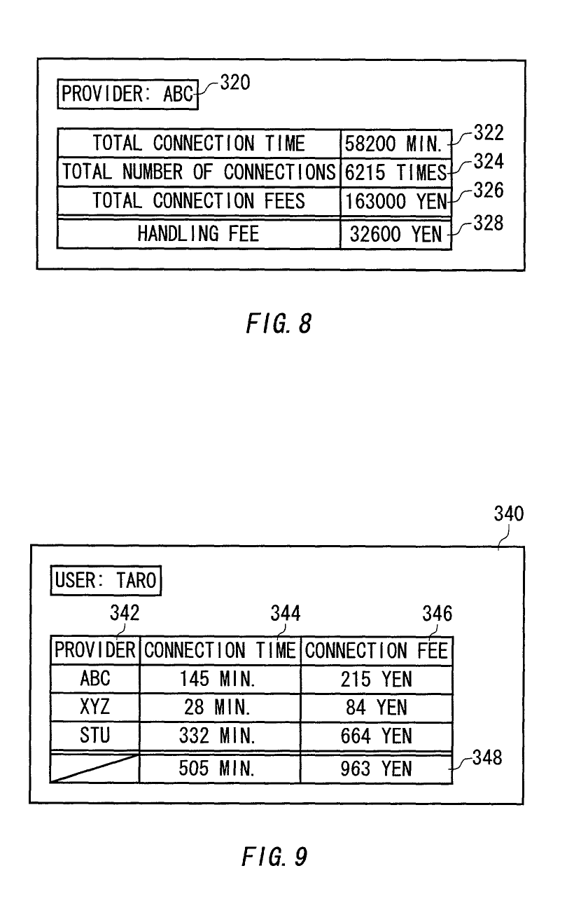

A charge unit 134 calculates a charge amount billed to the ISP 14 for the handling fee, and another charge amount billed to the user as connection fee, based on the content of the session table 132. FIG. 8 is a table showing the details of a debit note 320 to the provider ABC. In a total connection time column 322, the total connection time period during which the server 60 connects the user to this provider is recorded as “58200 minutes”. Similarly, the total number of connections established 324 is recorded as “6215”, and the total connection fee 326 is recorded as “163000 yen”. The total connection fee 326 is same as the “intermediary connection fee” in the handling fee scheme column 210 shown in FIG. 4. The handling fee 328 is 20% of the total connection fee according to the handling fee scheme column 210, and is thus recorded as “32600 yen”. Eventually, this amount of 32600 yen is billed to the provider as the handling fee. However, since the provider will charge “163000 yen” as the total connection fee 326, thus the difference therebetween may be remitted to the provider ABC, instead.

FIG. 9 is a table showing the details of a debit note 340 for the connection fee charge 340 issued to the user TARO. Here, entered are a provider 342 which held the session according to the TARO's request, the total connection time 344 for each provider, and the total connection fee 346 for said each provider. Lastly, the total connection fee of “963 yen” is entered in the debit note 340.

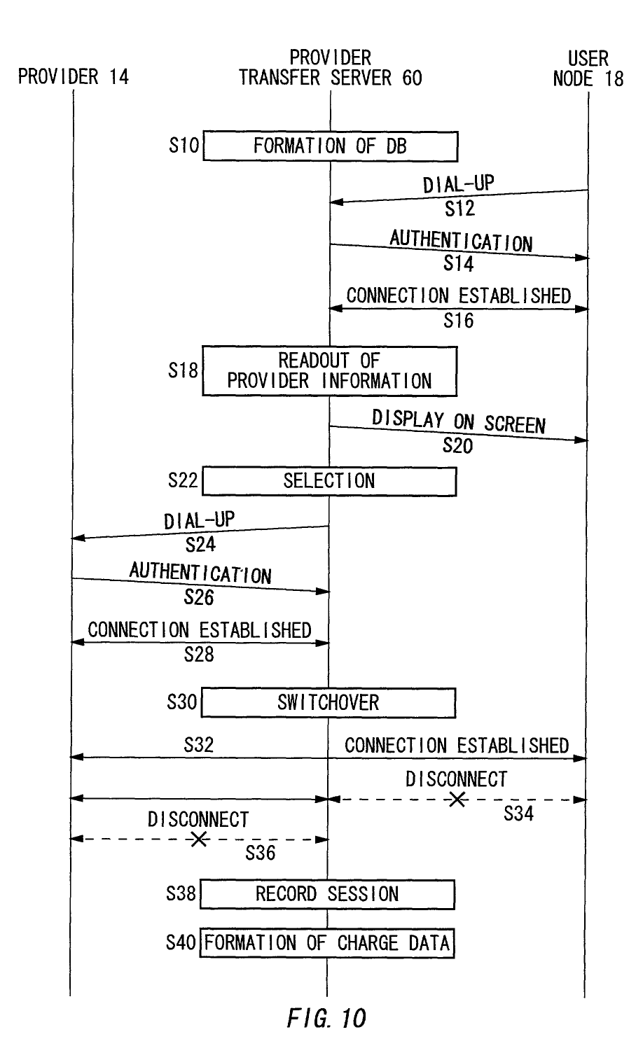

FIG. 10 shows procedures for a series of processes performed between the ISP 14, the server 60 and the user node 18 configured above. Prior to a provider transfer service, the server 60 generates the provider information database 110 and the user preference database 112 (S10). When the user node 18 contacts the serve 60 by a dial-up connection (S12), the server 60 authenticates this user (S14). If there is no problem then, a connection is established between the user node 18 and the server 60 (S16).

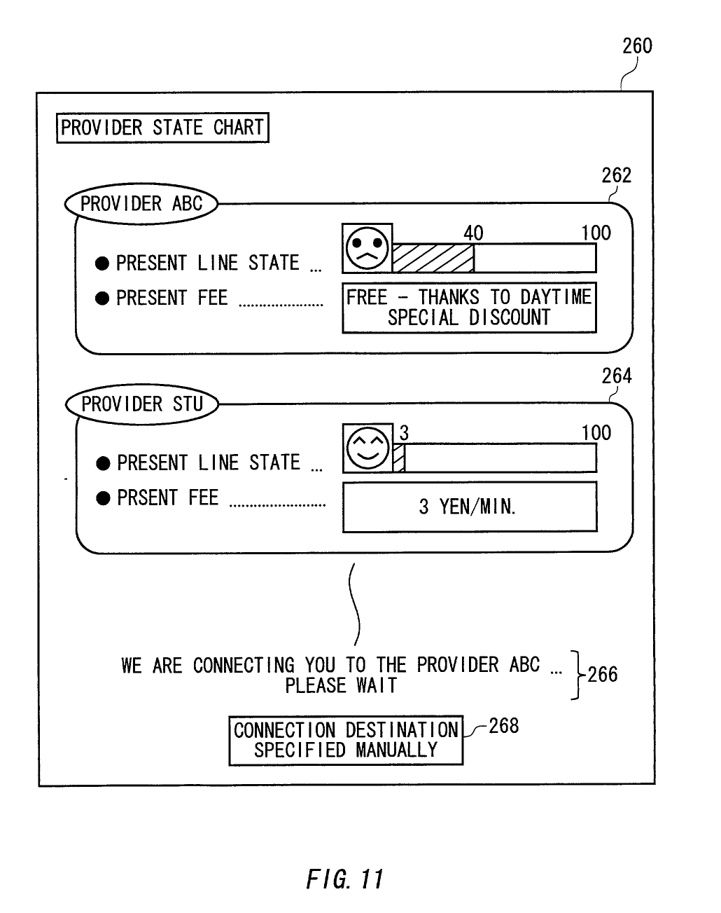

The server 60 reads out the data of the ISP 14 from the provider information database 110 (S18) and the read-out data are displayed on a screen of the user node 18 via the state provision unit 122 (S20). Simultaneously, the server 60 selects an ISP 14 for the user by referring to the user preference database 112 (S22), then the server 60 connects the user to the selected ISP 14 by a dial-up connection. FIG. 11 is a screen, showing the most recent state of the ISP 14, displayed on the user terminal. Here, a state concerning a provider ABC 262 and a state 264 concerning a provider STU are displayed in terms of both the line usage rate and the connection fee, and displayed is a connection display 266 which indicates that the server 60 (namely, the user) is being currently connected to the selected provider ABC. If the user wishes to change to another ISP 14, a new dial-up connection is attempted to establish a connection to a desired ISP 14 by clicking on a destination-manually-specified button 268. Since the connection is not made automatically when the user selects “confirm” in the request column 252 of the user preference database 112, the connection display 266 is not displayed and the destination-manually-specified button 268 is yet to be clicked.

The ISP 14 authenticates the server 60 which attempted to establish a connection by the dial-up, as a legitimate user (S26), SO that the connection is established between the ISP 14 and the server 60 (S28). Then, the selection circuit 104 switches from the path A to the path B (S30), and the connection is actually established between the ISP 14 and the user node 18 (S32) .

Thereafter, the user does arbitrary processes as he wishes under the Internet connection service realized through the ISP 14. When the connection is no longer wanted, the user disconnects the line between the first communication 100 and the user (S34). The, the line between the second communication unit 102 and the ISP 14 is also disconnected (S36), so that a session is completed and its record is added to the session table 132 (S38). Finally, billing data on the user and the ISP 14 are generated based on the session table 132 (S40) and then a series of processes are completed.

The present invention has been described based on the embodiments which are only exemplary. It is understood by those skilled in the art that there exist other various modifications to the combination of each component and each processing described and that such modifications are encompassed by the scope of the present invention. For example, combination of the internal structure of the server 60 shown in FIG. 3 may be modified to a large degree of freedom; the user preference data base 112 and the user authenticating unit 118 may be configured in an integrated manner; data of a line usage rate and so on which vary on a real-time basis may be managed in a manner such that said data are separated from the provider information database 110. Moreover, the server 60 may be provided with a full-scale line switching capability therein.

Moreover, there may be provided a plurality of the second communication units 102 such that they can be constantly or permanently connected to each of a plurality of the ISP's 14. In that case, the selection circuit 104 will select the second communication unit 102 connected constantly to the selected provider.

As for FIG. 10, various modifications are possible. For example, prior to or after establishment of the connection between the user node 18 and the server 60, the service state detecting unit 108 may access each provider in order to obtain the latest data on the providers.

According to the present embodiments, achieved is an network connection service with high usability and practicality and increased convenience for the users. Moreover, the service is achieved which is also profitable to the providers that provide the network connection servicing.

Although the present invention has been described by way of exemplary embodiments, it should be understood that many changes and substitutions may be made by those skilled in the art without departing from the spirit and the scope of the present invention which is defined by the appended claims.

What is claimed is:

1. A provider transfer server which provides a predetermined service for a user node, the server comprising:
a first communication unit which serves as an access point connected from the user node;
a second communication unit which connects the server to any one of access points owned by a plurality of connection service providers;
a detection unit which detects a connection service state of a plurality of the connection service providers;
a selection unit which selects a connection service provider based on the state detected by said detection unit and which instructs said second communication unit to get connected to an access point of the connection service provider selected; and
a communication channel establishing unit which establishes a communication channel between said first and second communication units in the event that said second communication unit is connected to the access point of the selected connection service provider.

2. A provider transfer server as recited in claim 1, further comprising a unit which registers in advance a user's preference for a connection service provider to be selected, wherein said selection unit chooses a connection service provider according to the user's preference, based on the state detected by said detection unit.

3. A provider transfer server as recited in claim 1, wherein said selection unit selects a connection service provider whose lines are relatively open at the time said detection unit detects the state.

4. A provider transfer server as recited in claim 2, wherein said selection unit selects a connection service provider whose lines are relatively open at the time said detection unit detects the state.

5. A provider transfer server as recited in claim 1, wherein said selection unit selects a connection service provider whose connection fee is relatively low, at the time said detection unit detects the state.

6. A provider transfer server as recited in claim 2, wherein said selection unit selects a connection service provider whose connection fee is relatively low, at the time said detection unit detects the state.

7. A provider transfer server as recited in claim 1, further comprising:
a recording unit which records sessions where the communication channel is established for the connection service provider, for each connection service provider; and
a charge unit which calculates a service fee incurred by a user for each connection service provider, based on data of the session recorded by said recording unit.

8. A provider transfer server as recited in claim 1, wherein said second communication unit and a plurality of the connection service providers are connected in an area more local than the Internet.

9. A provider transfer server as recited in claim 1, further comprising:
a unit which supplies the detected state to a terminal of the user node; and
an acquisition unit which acquires, from the user node, an instruction on selection of the connection service provider,
wherein said selection unit selects the connection service provider by referring to the instruction.

10. A provider transfer server as recited in claim 7, wherein said charge unit calculates, for each user node, an allotted charge due to a connection fee paid to the connection service provider by an operator of the provider transfer server on behalf of the user nodes, based on the data of the session.

11. A provider transfer server as recited in claim 8, wherein said charge unit calculates, for each user node, an allotted charge due to a connection fee paid to the connection service provider by an operator of the provider transfer server on behalf of the user nodes, based on the data of the session.

12. A provider transfer server as recited in claim 9, wherein said charge unit calculates, for each user node, an allotted charge due to a connection fee paid to the connection service provider by an operator of the provider transfer server on behalf of the user nodes, based on the data of the session.

13. A provider transfer server as recited in claim 1, further comprising:
an authenticating unit which authenticates that the user node is a legitimate user of the provider transfer server; and
an authentication data supplying unit which, upon request of authentication from the connection service provider, supplies data necessary for the requested authentication, wherein the provider transfer server is regarded as a user by the connection service provider.

14. A provider transfer server as recited in claim 1, wherein said selection unit includes a transceiver gate having an output disable terminal in the event that a path between said first communication unit and said second communication unit is of a digital signal path.

15. A provider transfer server as recited in claim 1, wherein said selection unit includes a transfer gate in the event that a path between said first communication unit and said second communication unit is an analog signal path.

16. A provider transfer server as recited in claim 1, wherein there are provided a plurality of said second communication units which are permanently connected to respective internet service providers, whereby said selection unit selects said second communication units.

17. A provider transfer server as recited in claim 1, wherein prior to or after establishment of a connection between the user node and the provider transfer server, the detection unit accesses each internet service provider so as to obtain the latest data on the internet service providers.

18. A method of providing a provider transfer service, the method comprising:
detecting, at a proper timing, a connection service state in a plurality of connection service providers which provide connection services to network;
receiving a request in which a user node requests to get connected to the network;
selecting a connection service provider according to the state detected; and
relaying a communication between the connection service provider thus selected and the user node,
wherein a intermediary process is performed in a manner such that the provider transfer service is treated as a user, by the connection service provider thus selected while the user node is treated as a user by the provider transfer service.
